(19) United States
(12) Patent Application Publication
(10) Pub. No.: US 2007/0003344 A1
(43) Pub. Date: Jan. 4, 2007

(54) Duplex automatic document feeding apparatus and a duplex document feeding method

(75) Inventors: Duk-young Lee, Suwon-si (KR); In-chang Seo, Seongnam-si (KR); Soo-yong Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/443,163

(22) Filed: May 31, 2006

(30) Foreign Application Priority Data
Jun. 29, 2005 (KR) 2005-57271
Jun. 29, 2005 (KR) 2005-57279

(51) Int. Cl. G03G 15/00

(52) U.S. Cl. 399/374

(57) ABSTRACT

A duplex automatic document feeder (DADF) includes a pickup roller, an image reading unit, and a discharge roller, and includes first, second, third, and fourth document feeding paths. When performing duplex scanning in the DADF, the document is fed from the pickup roller to the image reading unit through the second document feeding path, and then the document passes through the third document feeding path, which is a closed-loop feeding path, to reverse feed the document back to the image reading unit, so that both sides of the document are scanned. Next, the document is discharged by the discharge roller. When discharged, the front side of the document faces down corresponding to the document as stacked in a paper supply tray. Accordingly, an additional feeding path for rearrangement of the discharged document can be omitted, thereby improving duplex efficiency.

### CROSS-REFERENCE TO RELATED APPLICATIONS

This application claims the benefit of Korean Application No. 2005-57271 and No. 2005-57279, both filed Jun. 29, 2005, in the Korean Intellectual Property Office, the disclosures of which are incorporated herein by reference.

### BACKGROUND OF THE INVENTION

1. Field of the Invention

Aspects of the invention relate to a duplex document feeding method applied to a photocopier, a scanner, a facsimile or a multifunction apparatus, and a duplex automatic document feeder (DADF). More particularly, aspects of the invention relate to a duplex document feeding method and to a duplex automatic document feeder (DADF) for supplying a document sheet to an image reading unit by reversing a feeding direction of the document so that both sides of the document sheet can be sequentially scanned.

2. Description of the Related Art

An automatic document feeder (ADF), when used for copying, for example, enables continuous feeding of a plurality of document sheets to an image reading unit one by one without having to open a cover of a document tray and replace every sheet of the document. Also, a duplex ADF (DADF) supplies document sheets for duplex copying.

FIG. 1 schematically shows a conventional DADF. Referring to FIG. 1, simplex scanning operations will be described first. When a document sensor 12 detects and confirms existence of the document D, the document D is picked up by a pickup roller 13. The document D is separated by a register roller 14 sheet by sheet and fed to a scanning roller 16 by a feeding roller 15. The document D, being fed by the scanning roller 16, is pressed by a bar 18 and passed through an image reading unit 19. During this operation, the position of leading end(s) of the sheet(s) of the document D, with the document D including one or more sheets, is controlled by the scanning sensor 17. After the image reading unit 19 reads out images on the document D, the document D is discharged by a discharge roller 20. An image I on a front side of the document D with respect to a state of being stacked in a paper supply tray 11 is read by the image reading unit 19. After the document D passes through the discharge roller 20, the front side of the document D face(s) down. In summary, a document feeding path during the simplex scanning as above can be expressed by reference to FIG. 1 as \textcircled{a}→\textcircled{b}→\textcircled{c}→\textcircled{d}→\textcircled{e}→\textcircled{f}.

Further, referring to FIG. 1, duplex scanning operations are performed as follows. The document D stacked in the paper supply tray 11 passes through the pickup roller 13, the register roller 14, the feeding roller 15, the scanning roller 16, and the image reading unit 19 in the same manner as in the simplex scanning. After the image I on the front side of the document D, with respect to a state being stacked in the paper supply tray 11, is read by the image reading unit 19, the document D passes through a gate shutter 22 and the discharge roller 20. Since the trailing end of the document D is controlled by a gate sensor 21, the discharge roller 20 is reversed at a predetermined position so that the document D is/are fed in the opposite direction to the previous direction. Here, the gate shutter 22 is rotated unidirectionally by a shaft. As the document D is/are being reversely fed to the discharge roller 20 and passed through the gate shutter 22, the document D is/are perceived by a duplex sensor 23 and fed to the scanning roller 16 by a duplex roller 24. An image on the other side, that is, a rear side of the document D with respect to a state being stacked in the paper supply tray 11 is similarly read by the image reading unit 19, and then the sheet(s) of the document D is/are fed to the discharge roller 20. To summarize, for duplex scanning, the document D passes through a document feeding path by reference to FIG. 1 as \textcircled{a}→\textcircled{b}→\textcircled{c}→\textcircled{d}→\textcircled{e}→\textcircled{f}→\textcircled{e}→\textcircled{g}→\textcircled{c}→\textcircled{d}→\textcircled{e}→\textcircled{f}.

In the conventional DADF of FIG. 1, after completing the duplex scanning, the sheet(s) of the document D is/are discharged as turned over in comparison with the result of the simplex scanning. In other words, the rear side of the sheet(s) of the document D with respect to a state as being stacked in the paper supply tray 11 face(s) down and the front side faces up. Therefore, when copying a plurality of document sheets, the discharged document sheets are stacked as turned over in the reverse order. Therefore, the document sheets need to be rearranged by being passed through a path \textcircled{f}→\textcircled{e}→\textcircled{g}→\textcircled{c}→\textcircled{d}→\textcircled{e}→\textcircled{f} from the discharge roller 20. Through the process, the document D can be discharged with the front side facing down, as in the simplex scanning. Accordingly, the document feeding path for the duplex scanning in the conventional DADF of FIG. 1 can be summarized with reference to FIG. 1 as \textcircled{a}→\textcircled{b}→\textcircled{c}→\textcircled{d}→\textcircled{e}→\textcircled{f}→\textcircled{e}→\textcircled{g}→\textcircled{c}→\textcircled{d}→\textcircled{e}→\textcircled{f} \textcircled{e}→\textcircled{g}→\textcircled{c}→\textcircled{d}→\textcircled{e}→\textcircled{f}.

However, the conventional DADF, such as described and illustrated in FIG. 1, can have the following problems. First, the entire document feeding path is necessarily of a length that duplex efficiency can be deteriorated. The duplex efficiency can be expressed by {time elapsed for simplex feeding (simplex feed time)/time elapsed for duplex feeding (duplex feed time)}(2)(100%). The duplex efficiency of such conventional DADF typically does not exceed 70%. In this regard, since the duplex scanning requires an additional document feeding operation to rearrange the order of the document D, duplex efficiency would be more deteriorated, also causing waste of power and time.

Second, in the conventional DADF, such as illustrated and described with respect to FIG. 1, the lifespan of the assorted rollers used in the duplex scanning typically depends on the abrasion of the rollers, such as can be caused by the document feeding operation. The relatively long document feeding path of the conventional DADF can increase the frequency of use of the rollers, thereby promoting deterioration of the lifespan of the DADF.

Third, in the conventional DADF, such as illustrated and described with respect to FIG. 1, for the duplex scanning, the discharge roller 20 typically is required to be rotated bi-directionally and, accordingly, a bi-directional rotary motor (not shown) is usually necessary to drive the discharge roller 20. The bi-directional rotary motor is generally relatively expensive and complicated. Also, slippage of the sheets(s) of the document can be generated at the moment of converting rotational direction of the discharge roller 20, which can thereby deteriorate the precision of the document feeding operation.

In order to improve the duplex efficiency, a DADF employing two image reading units has been introduced. However, in spite of improved duplex efficiency, the DADF having two image reading units is typically not satisfactory in view of its relatively high manufacturing cost. In addition, a high-speed image processor is typically required in a DADF employing two image reading units for simultaneous processing of the read images, thereby further promoting an increase of the manufacturing cost.

### SUMMARY OF THE INVENTION

Aspects of the invention promote solving the above and/or other problems or disadvantages and promote providing various advantages in duplex feeding and scanning operations. Accordingly, an aspect of the present invention is to provide a duplex document feeding method that promotes improving efficiency of duplex feeding when performing duplex scanning, and a duplex automatic document feeder (DADF) that promotes improved efficiency of duplex feeding when performing duplex scanning.

In order to achieve the above-described and/or other aspects of the invention, there is provided a duplex automatic document feeder (DADF) including a pickup roller to pick up and feed a document stacked in a paper supply tray, an image reading unit to scan an image of the document, and a discharge roller to eject the scanned document, the DADF including: a first, or entry, document feeding path to feed, through the entry document feeding path, the document picked up by the pickup roller; a second, or connecting, document feeding path connected to a finishing end of the first document feeding path and extended to the image reading unit; a fourth, or reverse-feed, document feeding path formed as a closed-loop to reversely feed the document, through the reverse feed document feeding path, when one side of the document has been scanned by the image reading unit, back to the image reading unit for scanning of the other side of the document; and a fifth, or duplex scan discharge, document feeding path to feed the document, through the discharge document feeding path, when both sides of the document have been scanned by the image reading unit to the discharge roller, with the document being discharged through the discharge roller with an upward facing front side of the document, as stacked in the paper supply tray, being discharged facing down to arrange the document in a corresponding order to the document as stacked in the paper supply tray.

According to further aspects of the invention, when the document is fed to the image reading unit through the fourth, or reverse feed, document feeding path after simplex scanning, the document is fed in the opposite, or changed, direction as to when the document is being fed to the image reading unit through the second, or connecting, document feeding path. The fifth, or duplex scan discharge, document feeding path is partly overlapped with the second, or connecting, document feeding path at a section to reverse feed the document.

In further aspects of the invention, the DADF can further include a third, or simplex scan discharge, document feeding path to feed the document to the discharge roller, through the simplex scan discharge feeding path, when one side of the document is scanned by the image reading unit when performing simplex scanning.

In additional aspects of the invention, the DADF can further include a direction conversion member disposed near a location where the third, or simplex scan discharge, document feeding path and the fourth, or reverse-feed, document feeding path meet, the direction conversion member to selectively direct the document to the discharge roller, when the document has passed through the image reading unit during simplex scanning, and the direction conversion member to selectively direct the document to advance into the fourth, or reverse feed, document feeding path, when the document has passed through the image reading unit during duplex scanning.

According to another embodiment and aspect of the invention, there is provided a DADF including a pickup roller to pick up and feed a document stacked in a paper supply tray, an image reading unit to scan an image of the document, and a discharge roller to eject the scanned document, the DADF including: a second, or duplex scan entry, document feeding path to feed, through the entry document feeding path, the document from the pickup roller to the image reading unit to scan of one side of the document; a third, or reverse feed, document feeding path formed as a closed-loop to reversely feed back to the image reading unit, through the reverse feed document feeding path, the document of which one side is scanned to scan the other side of the document; and a fourth, or discharge, document feeding path to feed, through the discharge document feeding path, the document of which both sides are scanned from the image reading unit to the discharge roller, wherein the document is discharged through the discharge roller with an upward facing front side of the document, as stacked in the paper supply tray, facing down to arrange the document in a corresponding order to the document as stacked in the paper supply tray.

According to further aspects of the invention, when performing duplex scanning, a rear side of the document in relation to the document as stacked in the paper supply tray is scanned first by the image reading unit. Also, for simplex scanning, the DADF can further include a first, or simplex scan entry, document feeding path for feeding the document, through the simplex scan entry document feeding path, from the pickup roller to the image reading unit.

According to other aspects or embodiments of the invention, the pickup roller and the discharge roller feed the document in only one direction. Also, the second, or simplex scan entry, document feeding path, the third, or reverse feed, document feeding path, and the fourth, or discharge, document feeding path include at least one document feeding roller, and the document feeding roller feeds the document in only one direction.

In another aspect of the invention, the DADF can further include a first direction conversion member disposed near the image reading unit to advance the document passed through the pickup roller into the first, or simplex scan entry, document feeding path when performing simplex scanning, and advancing the document passed through the pickup roller into the second, or duplex scan entry, document feeding path when performing duplex scanning.

In an additional aspect of the invention, the DADF can further include a second direction conversion member disposed near a location where the first, or simplex scan entry, document feeding path and the third, or reverse feed, document feeding path meet whereby the document being fed to the image reading unit is directed to pass through the first, or simplex scan entry, document feeding path when performing simplex scanning, and is directed to advance the document of which one side is scanned by the image reading unit into the third, or reverse feed, document feeding path after passing through the second, or duplex scan entry, document feeding path when performing duplex scanning.

In another aspect of the present invention, there is provided a duplex document feeding method including: a first feeding operation to feed a document picked up by a pickup roller to an image reading unit to scan one side of the document; a second feeding operation to reverse a document feeding direction and then feed the document, of which one side has been scanned through the first feeding operation, back to the image reading unit to scan the other side of the document; and a third feeding operation to feed the document of which both sides are scanned to a discharge roller, wherein an additional document feeding operation to rearrange an order of the discharged document as the document was ordered prior to the first feeding operation, the additional document feeding operation not being related to an image reading operation, is absent in the duplex document feeding method.

While the invention is described in terms of document scanning and a DADF, the invention, and aspects thereof, also applies to other types of media, apparatus and methods that can be suitable for simplex and/or duplex scanning, such as film type media, or other suitable type media for scanning, in addition to paper type media, in practice and applications of the invention. As such, references herein to document also can correspond to other suitable medium or media, and the references to DADF and the various document feeding paths in the DADF can also apply to corresponding apparatus and feeding paths for other suitable media for simplex and duplex scanning.

Additional aspects and/or advantages of the invention are set forth in the description which follows or are evident from the description, or can be learned by the practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a conventional duplex automatic document feeder (DADF);

FIG. 2 is a schematic view of a DADF according to a first embodiment of the invention;

FIG. 3 is a schematic view of a DADF according to a second embodiment of the invention;

FIG. 4 is a schematic view of a DADF according to a third embodiment of the invention;

FIG. 5 is a schematic view of a DADF according to a fourth embodiment of the invention;

FIG. 6 is a view showing a document feeding path when performing simplex scanning in the DADF of FIG. 5; and

FIG. 7 is a view showing a document feeding path when performing duplex scanning in the DADF of FIG. 5.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

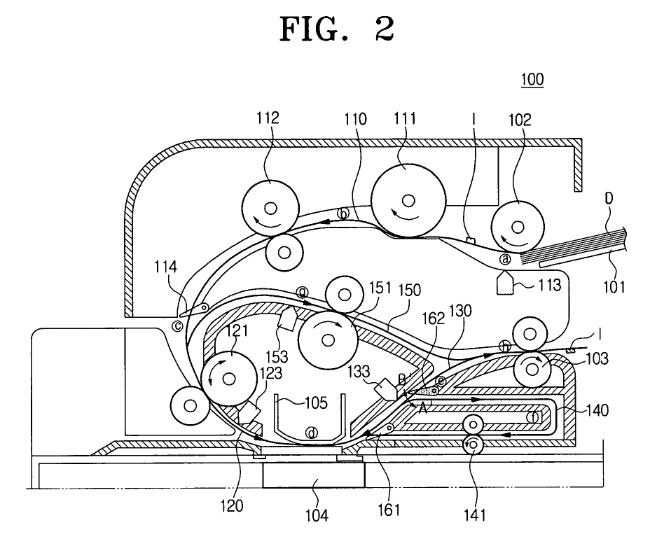

FIG. 2 shows a duplex automatic document feeder (DADF) 100 according to a first embodiment of the present invention. The DADF 100 includes a first document feeding path 110, a second document feeding path 120, a third document feeding path 130, a fourth document feeding path 140, and a fifth document feeding path 150.

In FIG. 2, the first, or entry, document feeding path 110 is a path to feed a document D picked up by a pickup roller 102. The pickup roller 102 separates an uppermost sheet of the document D stacked in a paper supply tray 101. A document sensor 113 perceives the document D stacked in the paper supply tray 101. A register roller 111 separately feeds each sheet of the document D being fed by the pickup roller 102, arranging leading ends of the document D. A register feeding roller 112 assists in providing continuous feeding of the document D along the document feeding direction. Also, when a document feeding section between the register roller 111 and a scanning feeding roller 121 is short, the register feeding roller 112 can be omitted.

Further, in FIG. 2, the second, or connecting, document feeding path 120 is connected to a finishing end of the first document feeding path 110 and extends to the image reading unit 104 so that the document D which has passed through the first document feeding path 110 is fed to the image reading unit 104. A first gate shutter 114 is formed at, or adjacent to, the finishing end of the first document feeding path 110. When performing simplex scanning, the gate shutter 114 guides the document D from the first document feeding path 110 to the second document feeding path 120. When performing duplex scanning, the first gate shutter 114 guides the document D of which both sides are to be scanned, that has again passed through the image reading unit 104 and fed back along the second document feeding path 120, to the fifth, or duplex scan discharge, document feeding path 150.

Continuing with reference to FIG. 2, the scanning feeding roller 121 advances the document D to the image reading unit 104. A scanning sensor 123 perceives the document D entering the image reading unit 104. When performing duplex scanning, the scanning feeding roller 121 reverses a feeding direction of the document D that has passed through the image reading unit 104, thereby feeding the document D from the second document feeding path 120 to the fifth document feeding path 150. Therefore, the scanning roller 121 is typically capable of bi-directional rotation. The image reading unit 104 reads out and digitalizes analog image information of the document D. In this regard, the image reading unit 104 includes image sensors, such as a charged coupled device (CCD) and a contact image sensor (CIS). A bar 105 biases the document D toward the image reading unit 104.

In the DADF 100, the third, or simplex scan discharge, document feeding path 130 is a path for feeding, through the document feeding path 130, the document D of which one side is scanned through the image reading unit 104 to a discharge roller 103. When performing simplex scanning, the document D is discharged by passing through the third document feeding path 130. A gate sensor 133 perceives the document D being fed after passing through the image reading unit 104. Also, in a section between the image reading unit 104 and the discharge roller 103, a dedicated feeding roller can be added. The discharge roller 103 finally ejects the document D onto a discharged-paper tray (not shown).

Also, in the DADF 100, the fourth, or reverse feed, document feeding path 140 is disposed in the vicinity of the gate sensor 133 on the document feeding path 130, as a closed loop document feeding path that diverges from the third document feeding path 130. With respect to a location where the third document feeding path 130 and the fourth document feeding path 140 meet, a second gate shutter 161 is disposed in the third document feeding path relatively closer to the image reading unit 104 and a third gate shutter 162 is disposed adjacent to the third document feeding path 130 relatively farther from the image reading unit 104.

In FIG. 2, the second gate shutter 161 guides the document D that has passed through the image reading unit 104 to the third document feeding path 130 during simplex scanning and guides the document D from the fourth document feeding path 140 back to the third document feeding path 130 during duplex scanning. The third gate shutter 162 functions as a direction conversion member according to an aspect of the invention. While the first and the second gate shutters 114 and 161 typically are not providing direction conversion, the third gate shutter 162 provides a direction conversion to change a direction, to change a feeding path for the document D. In this regard, the third gate shutter 162 can convert its direction to positions A′ and B′, as shown by a bi-directional arrow in FIG. 2. When performing simplex scanning, the third gate shutter 162 is disposed in the position A′ to let the document D pass by and not enter the fourth document feeding path 140. On the other hand, when performing duplex scanning, the third gate shutter 162 is converted to the position B′ so as to let the document D of which one side is scanned enter the fourth document feeding path 140.

Continuing with reference to FIG. 2, through the fourth document feeding path 140 which is a closed-loop path, the document D of which one side is scanned is turned over by 180° for scanning of the other side. The fourth document feeding path 140 includes a first duplex feeding roller 141 for feeding the document D in one direction.

Also, in FIG. 2, the fifth, or duplex scan discharge, document feeding path 150 is connected to a finishing end of the second document feeding path 120 to feed the document D, of which both sides have been scanned by the image reading unit 140, up to the discharge roller 103. A duplex sensor 153 for perceiving entry of the document D and a second duplex feeding roller 151 for feeding the document D to the discharge roller 103 are disposed on, or adjacent to, the fifth document feeding path 150. The fifth document feeding path 150 is partly overlapped with the second document feeding path 120 between the image reading unit 104 and the finishing end of the first document feeding path 110.

A method for duplex document feeding for duplex scanning and the operation of the DADF 100 according to an aspect of the will be described with reference to FIG. 2. As to simplex scanning, the operation and the document feeding path for simplex scanning are similar to that in a conventional ADF. As the document sensor 113 perceives existence of the document D, the pickup roller 102 picks up the document D stacked in the paper supply tray 101. The picked-up document D is fed to the image reading unit 104 through the first and the second document feeding paths 110 and 120. After the image reading unit 104 reads out an image on the document D, the document D is discharged by the discharge roller 103 through the third document feeding path 130. For simplex scanning, the third gate shutter 162 is disposed in the position A′.

Thus, in the DADF 100, the document feeding path for simplex scanning can be expressed with reference to FIG. 2 as \textcircled{a}→\textcircled{b}→\textcircled{c}→\textcircled{d}→\textcircled{e}→\textcircled{h}. During simplex scanning, the image reading unit 104 reads out an upward facing image I on a front side of the document D as stacked in the paper supply tray 101. When the document D passes through the discharge roller 103, the front side of the document D faces down. Alternatively, an upward facing rear side of the document D, as stacked in the paper supply tray 101, can be scanned first by the image reading unit 104.

A method and operation for duplex document scanning in the DADF 100 according to aspects of the invention will now be described. The document feeding path from the pickup roller 102 to the image reading unit 104 is similar to that in the processes of simplex scanning. In other words, the document D is fed to the image reading unit 104 passing through the first and the second document feeding paths 110 and 120, during which one side of the document D is scanned (first feeding operation).

In the duplex document method and operation for scanning in the DADF 100, the third gate shutter 162 is converted to the position B′. Therefore, the document D of which one side is scanned can be advanced by the third gate shutter 162 to the fourth document feeding path 140. The document D is passed through the first duplex feeding roller 141, the second gate shutter 161 positioned to feed the document D through the second document feeding path 120, and the image reading unit 104 (second feeding operation). Since the document D is turned over through the fourth document feeding path 140, the other side, that is, a rear side of the document D can be scanned through the image reading unit 104.

Continuing with reference to FIG. 2, the document D of which both sides are scanned is fed to the discharge roller 103 and discharged to the outside of the DADF 100 (third feeding operation). More specifically, the document D of which the other side of the document D has been scanned is fed reversely, or in a reverse direction, along the second document feeding path 120 to the direction in which the document D passed through the second document feeding path 120 during the first feeding operation (fourth feeding operation). In other words, the document D is passed through the scanning feeding roller 121 and the first gate shutter 114, positioned to feed the document D through the fifth document feeding path 150, and discharged through the second duplex feeding roller 151 and the discharge roller 103.

When performing duplex scanning in the DADF 100, the document D is passed through the first through the fifth document feeding paths 110 to 150, as previously described. The document feeding path for duplex scanning in the DADF 100 can be summarized and expressed with reference to FIG. 2 as \textcircled{a}→\textcircled{b}→\textcircled{c}→\textcircled{d}→\textcircled{e}→\textcircled{f}→\textcircled{d}→\textcircled{c}→\textcircled{g}→\textcircled{h}. When duplex scanning is performed, the document D is therefore discharged with the upward facing front side of the document D, as stacked in the paper supply tray 101, facing down to arrange the document D in corresponding order to the document D as stacked in the paper supply tray 101. Alternatively, an upward facing rear side of the document D, as stacked in the paper supply tray 101, can be discharged facing down to arrange the document D in corresponding order to the document D as stacked in the paper supply tray 101.

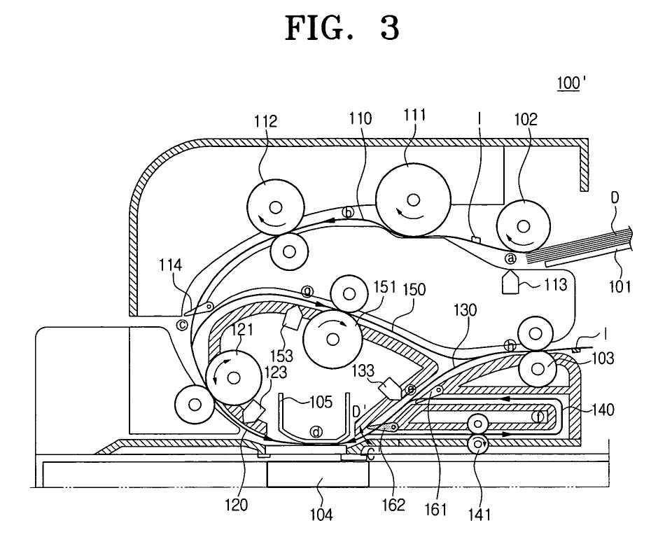

FIG. 3 shows the DADF 100′ according to a second embodiment of the invention. In the DADF 100′ of FIG. 3, when performing simplex scanning, the first gate shutter 114 guides the document D from the first document feeding path 110 to the second document feeding path 120. When performing duplex scanning, the first gate shutter 114 guides the document D of which both sides are to be scanned, that has again passed through the image reading unit 104 and fed back along the second document feeding path 120, to the fifth, or discharge, document feeding path 150. However, in the second embodiment of the DADF 100′, the positions of the third gate shutter 162 and the second gate shutter 161 are exchanged in the third document feeding path 130 in comparison with the first embodiment of the DADF 100. As in the DADF 100 of FIG.2, in the DADF 100′, the second gate shutter 161 guides the document D that has passed through the image reading unit 104 to the third document feeding path 130 during simplex scanning and guides the document D from the fourth document feeding path back to the third document feeding path 130 during duplex scanning. The feeding direction of the document D is reversed in the fourth document feeding path 140 from the feeding direction of the document D in the DADF 100. The processes and operations for simplex and duplex scanning in the DDF 100′ will be described as follows.

During simplex scanning in the DADF 100′, the document feeding path is similar to that in the DADF 100, which can be summarized with reference to FIG. 3 as \textcircled{a}→\textcircled{b}→\textcircled{c}→\textcircled{d}→\textcircled{e}→\textcircled{h}. During simplex scanning in the DADF 100′, the third gate shutter 162 is disposed in a position C′. As in the DADF 100, the third gate shutter 162 in the DADF 100′ provides a direction conversion to change a direction, to change a feeding path for the document D.

When performing duplex scanning in the DADF 100′, the third gate shutter 162 is converted to a position D′ so that the document D, of which one side has been scanned by the image reading unit 104, can be advanced to the fourth document feeding path 140 by the third gate shutter 162. As passing through the first duplex feeding roller 141, the document D is turned over by 180° to be reversely fed back to the second document feeding path 120. As the document D passes through the second gate shutter 161 positioned to feed the document D back through the second document feeding path 120 and then the image reading unit 104 again, the other side of the document D is scanned. In the same manner as the embodiment of the DADF 100, the document D is discharged by passing through the second and the fifth document feeding paths 120 and 150, and the discharge roller 103.

Thus, in the method and operation when performing duplex scanning in the DADF 100′ of FIG. 3, the document feeding path can be summarized as \textcircled{a}→\textcircled{b}→\textcircled{c}→\textcircled{d}→\textcircled{f}→\textcircled{e}→\textcircled{d}→\textcircled{c}→\textcircled{g}→\textcircled{h}. In the second embodiment of the DADF 100′, as in the DADF 100, when performing duplex scanning, the upward facing front side of the document D, as stacked in the paper supply tray 101, is discharged facing down to arrange the document in a corresponding order to the document D as stacked in the paper supply tray 101. Alternatively, an upward facing rear side of the document D, as stacked in the paper supply tray 101, can be discharged facing down to arrange the document D in corresponding order to the document D as stacked in the paper supply tray 101.

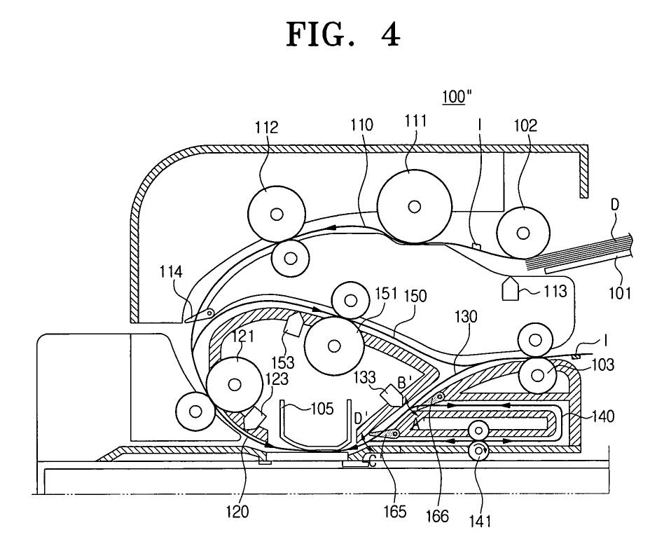

FIG. 4 shows a DADF 100″ according to a third embodiment of the invention. In the DADF 100″, when performing simplex scanning, the first gate shutter 114 guides the document D from the first document feeding path 110 to the second document feeding path 120. When performing duplex scanning, the first gate shutter 114 guides the document D of which both sides are to be scanned, that has again passed through the image reading unit 104 and fed back along the second document feeding path 120, to the fifth, or discharge, document feeding path 150, similar to the gate shutter 114 in the DADFs 100 and 100′.

Continuing with reference to the DADF 100″, the fourth and fifth gate shutters 165 and 166 capable of converting positions thereof to direct the document D are mounted on or adjacent to the third document feeding path 130. The first through fifth document feeding paths 110 to 150 are similar to those of the DADF 100 and the DADF 100′ of the first and the second embodiments, and the document feeding paths for simplex and duplex scanning in the DADF 100″ can be determined according to disposition, or positions, of the two gate shutters 165 and 166. In the DADF 100″, the fourth and fifth gate shutters 165 and 166 one of respectively guide the document D that has passed through the image reading unit 104 to the third document feeding path 130 during simplex scanning, and respectively one of guide the document D from the fourth document feeding path back to the third document feeding path 130 during duplex scanning, depending upon the position of the gate shutters and the direction of the document D passing through the fourth document feeding path 140. The gate shutters 165 and 166 thereby function respectively as either the second gate shutter 161 or the third gate shutter 162 of the DADFs 100 or 100′ in this regard, with one of the gate shutters 165 and 166 functioning as the third gate shutter 162 to provide a direction conversion to change a direction, to change a feeding path for the document D, depending upon the direction of the document D passing through the fourth document feeding path 140.

Continuing with reference to the DADF 100″, when performing simplex scanning, the fourth and the fifth gate shutters 165 and 166 are disposed in positions C′ and A′ in FIG. 4, respectively. The document feeding path for simplex scanning in the DADF 100″ is the same as previously described, with respect to thee previous embodiments of the DADF 100 and the DADF 100′.

However, in the DADF 100″, during duplex scanning, when the fourth gate shutter 165 is disposed in the position D′, the fifth gate shutter 166 is disposed in the position A′ of FIG. 4, the document feeding path for the document D is the same as previously described with respect to the DADF 100′ in the second embodiment as shown in FIG. 3. Meanwhile, in the DADF 100″, during duplex scanning, when the fourth gate shutter 165 is disposed in the position C′, the fifth gate shutter 166 is disposed in the position B′ of FIG. 4, the document feeding path is the same as previously described with respect to the DADF 100.

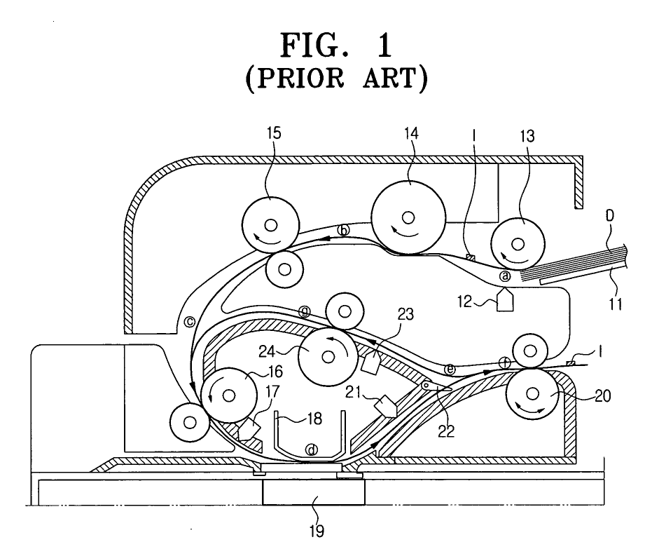

For duplex scanning in a conventional DADF, such as illustrated in FIG. 1, having a single image reading unit, the document D is typically fed back to pass through the image reading unit once more for rearrangement of the order of the sheet(s) of the document D. However, as described above, the DADF according to embodiments and aspects of the invention, such as the DADF 100, DADF 100′ and the DADF 100″, is capable of converting a document feeding path to scan the other side of the document D, such as under control of a controller, such as a processor, microprocessor or an application specific integrated circuit (ASIC), with associated memory and software or programming, for controlling operation of the DADFs 100, 110′ and 100″. Therefore, in a DADF of the invention, such as the DADF 100, DADF 100′ and the DADF 100″, when the document D is discharged by the discharge roller 103, the upward facing front side of the document D, as stacked in the paper supply tray 101, faces down to arrange the document D in a corresponding order to the document D as stacked in the paper supply tray 101. As mentioned, alternatively, an upward facing rear side of the document D, as stacked in the paper supply tray 101, can be discharged facing down to arrange the document D in corresponding order to the document D as stacked in the paper supply tray 101. Accordingly, in DADFs, methods and operations according to aspects of the invention, an additional document feeding process or additional structure for rearrangement of the document D to be discharged is not required. As a result, duplex efficiency, printing speed, and the lifespan of the DADF can be improved according to aspects of the invention.

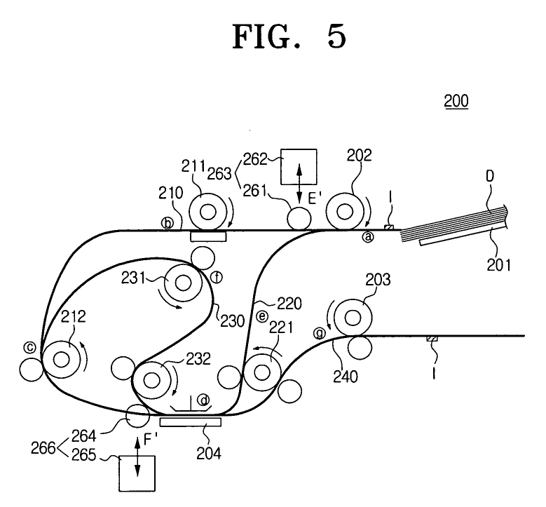

FIG. 5 schematically shows a DADF 200 according to a fourth embodiment of the present invention. In the first through the third embodiments, for the DADF 100, DADF 100′ and the DADF 100″, the document feeding paths from the pickup roller 102 to the image reading unit 104 for simplex scanning are all the same when performing both simplex scanning and duplex scanning, as previously described. However, according to another aspect of the invention in the fourth embodiment of the DADF 200, the document feeding paths from the pickup roller 202 to the image reading unit 204 differ from each other when performing simplex scanning and duplex scanning.

While the previous embodiments of the invention of FIGS. 2 to 4 adopt a gate shutter as the direction conversion member for reversing the document feeding direction for duplex scanning, as previously described, the DADF 200 uses pressing members 263 and 266 respectively comprising pressing rollers 261 and 264 and solenoids 262 and 265 to selectively press the pressing rollers 261 and 264 by electric signals, such as under control of a controller, such as a processor, microprocessor or an application specific integrated circuit (ASIC), with associated memory and software or programming, for controlling operation of the DADF 200. However, application of the gate shutter, or other suitable diverting mechanism, can also be used in the DADF 200 as a direction conversion member to selectively change the document feeding paths for simplex scanning and duplex scanning, in a manner as previously described. As shown in FIG. 5, the first and the second pressing members 263 and 266 let the document D pass by during simplex scanning, but operate to reverse, or change, the document feeding direction, or document feeding path, during duplex scanning. More specifically, when the solenoids 262 and 265 are operated, the pressing rollers 261 and 264 bias the document D in arrowed directions E′ and F′, thereby reversing, or changing, the document feeding direction or the document feeding path.

Continuing with reference to FIGS. 5 to 7, the DADF 200 according to embodiments and aspects of the invention includes a first, or simplex scan entry, document feeding path 210, a second, or duplex scan entry, document feeding path 220, a third, or reverse feed, document feeding path 230, and a fourth, or discharge, document feeding path 240.

In this regard, as illustrated in FIG. 5, the pressing member 263, as a first direction conversion member is disposed adjacent to the pick up roller 202, wherein the pressing member 263 directs the document D that has passed through the pickup roller 202 to advance into the first, or simplex scan entry, document feeding path 210 when performing simplex scanning, and wherein the pressing member 263 directs the document D that has passed through the pickup roller 202 to advance into the second, or duplex scan entry, document feeding path 220 when performing duplex scanning. Also, the pressing member 266, as a second direction conversion member, is disposed adjacent to a location where the first, or simplex scan entry, document feeding path 210 and the third, or reverse feed, document feeding path 230 meet, wherein the pressing member 266 directs the document D being fed to the image reading unit 204 through the first, or simplex scan entry, document feeding path 210 to continue to pass through to the fourth, or discharge document, feeding path 240 when performing simplex scanning, and wherein the pressing member 266 directs the document D, when one side of the document D has been scanned by the image reading unit 204 after passing through the second, or duplex scan entry, document feeding path 220, to advance into the third, or reverse feed, document feeding path 230 to scan the other side of the document D by the image reading unit 204 when performing duplex scanning.

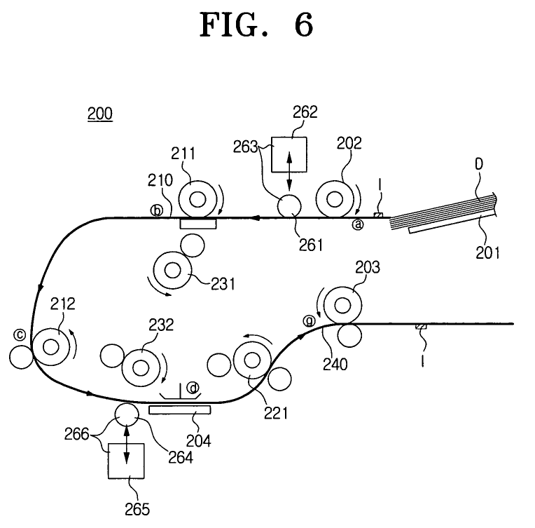

Referring to FIGS. 5 and 6, aspects of the DADF 200 of the invention for simplex scanning are illustrated. For simplex scanning in the DADF 200, the first document feeding path 210, as a simplex scan entry document feeding path, extends from a pickup roller 202 to an image reading unit 204. The first document feeding path 210 includes a register feeding roller 211 and a scanning feeding roller 212 for feeding the document D.

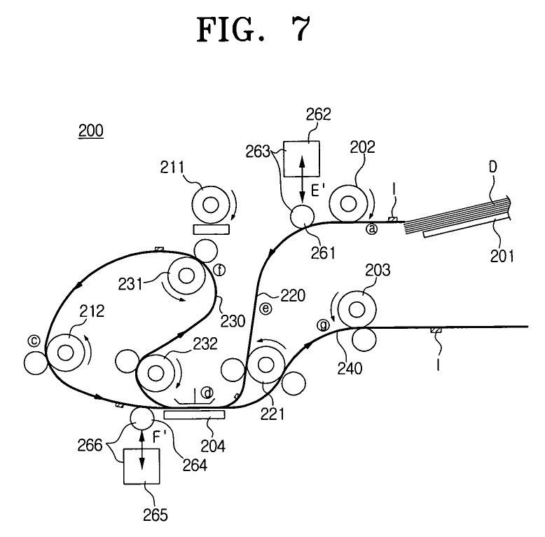

Continuing with reference to FIGS. 5 and 7, aspects of the DADF 200 of the invention for duplex scanning are illustrated. For duplex scanning in the DADF 200, the second document feeding path 220, as a duplex scan entry document feeding path, extends from the pickup roller 202 to the image reading unit 204. A first duplex feeding roller 221 for feeding the document D is mounted in the second document feeding path 220. The first pressing member 263 for reversing, or changing, the document feeding direction to the arrowed direction E′ is disposed near a location where the first and the second document feeding paths 210 and 220 meet so as to advance the document D being fed by the pickup roller 202 into the second document feeding path 220.

Further, with reference to FIGS. 5 and 7, as to duplex scanning in the DADF 200 of the invention, the third document feeding path 230, as a reverse feed document feeding path, is a closed-loop path for the document D, whereby when one side of the document D has been scanned through the image reading unit 204, the document D in the third document feeding path 230 is then turned over by 180° to again feed the document D to the image reading unit 204 to scan the other side of the document D by the image reading unit 204. The third document feeding path 230 includes second and third duplex feeding rollers 231 and 232. As illustrated in FIGS. 5 to 7, part of the third document feeding path 230 from the scanning feeding roller 212 to the image reading unit 204 overlaps with the first document feeding path 210. The second pressing member 266 is disposed in the vicinity of the image reading unit 204 to reverse, or change, the feeding direction of the document D, that has passed through the image reading unit 204 on the second document feeding path 220, to the arrowed direction F′ and thereby advance the document D into the third document feeding path 230.

As can be seen from FIGS. 5 to 7, according to aspects of the invention, in the DADF 200, the fourth document feeding path 240, as a discharge document feeding path, extends from the image reading unit 204 in the direction of the discharge roller 203, and is used for both simplex scanning and duplex scanning. The document D which has been scanned through the image reading unit 204 is fed along the fourth document feeding path 240 to the discharge roller 203. In the fourth document feeding path 240, the first duplex feeding roller 221 feeds the document D along the fourth feeding path 240, in addition to feeding the document D along the second document feeding path 220 for the duplex scanning, as previously described.

Referring to FIG. 6, the simplex scanning operation and the document feeding path in the DADF 200 according to the fourth embodiment of the invention is described as follows. The document feeding path for simplex scanning in the DADF 200 is similar to the document feeding paths in the DADFs 100, 100′ and 100″. Therefore, for simplex scanning in the DADF 200, the document D stacked in a paper supply tray 201 is passed through the first document feeding path 210, scanned by the image reading unit 204 for image reading, then passed through the fourth document feeding path 240 and discharged by the discharge roller 203. During simplex scanning, the first and the second pressing members 263 and 266 do not operate so as to permit the document D to pass along the first document feeding path 210 without passing along the second feeding path 220. The document feeding path for simplex scanning in the DADF 200 can be summarized with reference to FIG. 6 as \textcircled{a}→\textcircled{b}→\textcircled{c}→\textcircled{d}→\textcircled{g}. In the simplex scanning, according to aspects of the invention, in the DADF 200 the front side of the document D, which is stacked facing upward in the paper supply tray 201, is scanned for image reading by the image reading unit 204. When the document D is discharged from the DADF 200 after completion of the simplex scanning, the upward facing front side of the document D, as stacked in the paper supply tray 201, faces down to arrange the document D in a corresponding order to the document D as stacked in the paper supply tray 201. Alternatively, an upward facing rear side of the document D, as stacked in the paper supply tray 201, can be discharged facing down to arrange the document D in corresponding order to the document D as stacked in the paper supply tray 201.

Referring to FIG. 7, the duplex scanning operation and the document feeding path in the DADF 200 is described as follows. During duplex scanning, the document D picked up by the pickup roller 202 is advanced into the second document feeding path 220 by the first pressing member 263. As the document D passes through the second document feeding path 220, the rear side of the document D is first scanned by the image reading unit 204. After passing through the image reading unit 204, the document D is advanced into the third document feeding path 230 by the second pressing member 266. After passing through the third document feeding path 230, the document D again passes through the image reading unit 204. Since the document D is turned over by 180° while passing through the third document feeding path 230, the front side of the document D is now scanned by the image reading unit 204. Next, the document D passes through the fourth document feeding path 240 and is discharged to the outside by the discharge roller 203. The document feeding path for the duplex scanning in the DADF 200 can be summarized with reference to FIG. 7 as \textcircled{a}→\textcircled{e}→\textcircled{d}→\textcircled{f}→\textcircled{c}→\textcircled{d}→\textcircled{g}.

Like DADFs 100, 100′ and 100″, in the duplex scanning operation in the DADF 200, the upward facing front side of the document D, as stacked in the paper supply tray 201, is discharged facing down to arrange the document D in a corresponding order to the document D as stacked in the paper supply tray 201. Also, as mentioned, an upward facing rear side of the document D, as stacked in the paper supply tray 201, can be discharged facing down to arrange the document D in corresponding order to the document D as stacked in the paper supply tray 201. Therefore, in the DADF 200 of the fourth embodiment of the invention, an additional document feeding operation for rearrangement of order of the discharged document D is not required, thereby promoting an improvement in the duplex scanning efficiency and promoting a saving of time and power. Moreover, according to aspects of the invention, the frequency of use of the rollers in the DADF 200 of the invention can be decreased, thereby also promoting an improvement of the lifespan of the DADF.

According to the fourth embodiment of the present invention, in the DADF 200 the rollers for feeding the document D are rotated unidirectionally. The conventional DADF typically necessitates a bi-directional motor for rotating at least one of the feeding rollers bi-directionally for duplex scanning. However, the DADF 200, according to aspects of the invention, can perform duplex scanning with a unidirectional driving motor, thereby promoting a saving of the manufacturing cost and promoting a simplifying of the program for the scanning operations.

As can be appreciated from the above description, embodiments and aspects of the invention can be advantageous for scanning operations as follows.

One advantageous aspect of the invention is that since the whole document feeding path for duplex scanning is shortened, the duplex efficiency can be highly improved. In this regard, since the document D is discharged with the front side of the document D f facing down, the document D does not require additional feeding for rearrangement of the order of the sheet(s) of the document D. Therefore, power and time can be saved in the DADFs, methods and operations of the invention.

Another advantageous aspect of the invention is that the lifespan of the DADF can be improved. Since the lifespan of the various feeding rollers in a DADF typically depends on the abrasion caused by the feeding operation, the reduced frequency of use of the feeding rollers can thereby improve the lifespan of the DADF.

A further advantageous aspect of the invention is that a savings in the manufacturing cost and a simplifying of the program for the scanning operations are promoted. Since duplex scanning, according to aspects of the invention, can be achieved with the unidirectional driving motor, the bi-directional driving motor used in the conventional DADF can be omitted for duplex scanning. Also, slippage of the document typically generated in the conventional DADF when converting a rotational direction of the roller can be prevented, thereby promoting an improvement in the precision of the document feeding operation.

The foregoing embodiments and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A duplex automatic document feeder (DADF) including a pickup roller to pick up and feed a document stacked in a paper supply tray, an image reading unit to scan an image of the document, and a discharge roller to eject the scanned document, the DADF comprising:
an entry document feeding path to feed, through the entry document feeding path, the document picked up by the pickup roller;
a connecting document feeding path connected to a finishing end of the entry document feeding path and extended to the image reading unit;
a reverse feed document feeding path formed as a closed-loop to reverse feed the document, through the reverse feed document feeding path, when one side of the document has been scanned by the image reading unit, back to the image reading unit to scan the other side of the document, when duplex scanning of the document is performed; and
a duplex scan discharge document feeding path to feed the document to the discharge roller, when both sides of the document are scanned by the image reading unit,
wherein the document is discharged from the discharge roller with an upward facing side of the document, as stacked in the paper supply tray, facing down to arrange the document in a corresponding order to the document as stacked in the paper supply tray.

2. The DADF of claim 1, wherein, when the document is fed to the image reading unit through the reverse feed document feeding path to perform duplex scanning, the document is then fed through the connecting document feeding path to the image reading unit in the opposite direction to the direction the document was fed for simplex scanning to the image reading unit.

3. The DADF of claim 2, wherein the duplex scan discharge document feeding path is partly overlapped with the connecting document feeding path at a section to reverse feed the document.

4. The DADF of claim 3, further comprising:
a simplex scan discharge document feeding path to feed the document, when only one side of the document is scanned by the image reading unit, to the discharge roller when performing simplex scanning.

5. The DADF of claim 4, further comprising:
a direction conversion member disposed adjacent to a location where the simplex scan discharge document feeding path and the reverse feed document feeding path meet,
wherein the direction conversion member directs the document to the simplex scan discharge document feeding path to feed the document to the discharge roller after the document has passed through the image reading unit when performing simplex scanning, and
wherein the direction conversion member directs the document to advance into the reverse feed document feeding path after the document has passed through the image reading unit when performing duplex scanning.

6. A duplex automatic document feeder (DADF) including a pickup roller to pick up and feed a document stacked in a paper supply tray, an image reading unit to scan an image of the document, and a discharge roller to eject the scanned document, the DADF comprising:
a duplex scan entry document feeding path to feed the document, through the duplex scan entry document feeding path, from the pickup roller to the image reading unit to first scan one side of the document;
a reverse feed document feeding path formed as a closed-loop to reverse feed the document, through the reverse feed document feeding path, when one side of the document has been scanned by the image reading unit, back to the image reading unit to scan the other side of the document, when duplex scanning of the document is performed; and
a discharge document feeding path to feed the document, through the discharge document feeding path, to the discharge roller, when both sides of the document are scanned by the image reading unit,
wherein the document is discharged from the discharge roller with an upward facing side of the document, as stacked in the paper supply tray, facing down to arrange the document in a corresponding order to the document as stacked in the paper supply tray.

7. The DADF of claim 6, wherein a rear side of the document, as stacked in the paper supply tray, is scanned first by the image reading unit.

8. The DADF of claim 7, further comprising:
a simplex scan entry document feeding path to feed the document, through the simplex scan entry document feeding path, from the pickup roller to the image reading unit when simplex scanning is performed.

9. The DADF of claim 6, wherein the pickup roller and the discharge roller feed the document in only one direction.

10. The DADF of claim 6, wherein the duplex scan entry document feeding path, the reverse feed document feeding path, and the discharge document feeding path include at least one document feeding roller, and wherein the document feeding roller feeds the document in only one direction.

11. The DADF of claim 10, wherein the reverse feed document feeding path is partly overlapped with a simplex scan entry document feeding path, the simplex scan entry document feeding path to feed the document from the pickup roller to the image reading unit when only simplex scanning is performed.

12. The DADF of claim 11, further comprising:
a first direction conversion member disposed adjacent to the pick up roller,
wherein the first direction conversion member directs the document that has passed through the pickup roller to advance into the simplex scan entry document feeding path when performing simplex scanning, and
wherein the first direction conversion member directs the document that has passed through the pickup roller to advance into the duplex scan entry document feeding path when performing duplex scanning.

13. The DADF of claim 12, further comprising:
a second direction conversion member disposed adjacent to a location where the simplex scan entry document feeding path and the reverse feed document feeding path meet,
wherein the second conversion member directs the document being fed to the image reading unit through the simplex scan entry document feeding path to continue to pass through to the discharge document feeding path when performing simplex scanning, and
wherein the second conversion member directs the document, when one side of the document has been scanned by the image reading unit after passing through the duplex scan entry document feeding path, to advance into the reverse feed document feeding path to scan the other side of the document by the image reading unit when performing duplex scanning.

14. A document feeding and scanning method, comprising:
a first feeding operation to feed a document picked up by a pickup roller to an image reading unit to scan one side of the document;
a second feeding operation to reverse a document feeding direction and to feed the document, when the one side of the document has been scanned through the first feeding operation, back to the image reading unit to scan the other side of the document; and
a third feeding operation to feed the document, when both sides of the document have been scanned, to a discharge roller,
wherein an additional document feeding operation to rearrange an order of the discharged document, the additional document feeding operation not being related to an image reading operation, is not included.

15. A document feeding and scanning method, comprising:
a first feeding operation to feed a document picked up by a pickup roller to an image reading unit to scan one side of the document;
a second feeding operation to reverse a document feeding direction and to feed the document, when the one side of the document has been scanned through the first feeding operation and the other side of the document is to be scanned, back to the image reading unit to scan the other side of the document; and
a third feeding operation to feed the document, when scanning of the document has been completed, to a discharge roller, to discharge the document,
wherein the document is discharged without an additional document feeding operation to rearrange the document in a corresponding order to an order of the document as fed in the first feeding operation.

16. The method of claim 15, wherein the document is fed in the first feeding operation from a supply tray, and a side of the document, facing upward as stacked in the supply tray, is discharged from the discharge roller facing down to arrange the document in a corresponding order to the document as stacked in the paper supply tray.

17. The method of claim 15, wherein the document is fed in the first feeding operation from a supply tray, and an upward facing front side of the document, as stacked in the supply tray, is discharged from the discharge roller facing down to arrange the document in a corresponding order to the document as stacked in the paper supply tray.

18. The method of claim 15, further comprising:
selectively directing the document, by a direction conversion member, to feed the document to the discharge roller after the first feeding operation and the document has passed through the image reading unit, without performing the second feeding operation, when performing simplex scanning, and
selectively directing the document, by the direction conversion member, to reverse a document feeding direction and feed the document, when the one side of the document has been scanned through the first feeding operation and the other side of the document is to be scanned, back to the image reading unit to scan the other side of the document in the second feeding operation, when performing duplex scanning.

19. The method of claim 15, further comprising:
selectively feeding the document to the discharge roller after the first feeding operation and the document has passed through the image reading unit, without performing the second feeding operation, when performing simplex scanning, and
selectively reversing a document feeding direction and feeding the document, when the one side of the document has been scanned through the first feeding operation and the other side of the document is to be scanned, back to the image reading unit to scan the other side of the document in the second feeding operation, when performing duplex scanning.

20. The method of claim 15, wherein the first feeding operation and the third feeding operation are performed, without performing the second feeding operation, when only simplex scanning is performed.

21. A document feeding and scanning method, comprising:
a first feeding operation to feed a document picked up by a pickup roller to an image reading unit to scan one side of the document;
a second feeding operation to reverse a document feeding direction and to feed the document, when the one side of the document has been scanned through the first feeding operation and the other side of the document is to be scanned, back to the image reading unit to scan the other side of the document; and
a third feeding operation to feed the document, when scanning of the document has been completed, to a discharge roller, to discharge the document,
wherein a side of the document, facing upward as the document is fed in the first feeding operation, is discharged from the discharge roller facing down to arrange the document in a corresponding order to the document as fed in the first feeding operation.

22. The method of claim 21, wherein the document is discharged from the discharge roller with an upward facing front side of the document, as the document is fed in the first feeding operation, facing down to arrange the document in a corresponding order to the document as fed in the first feeding operation.

23. The method of claim 21, wherein the first feeding operation and the third feeding operation are performed, without performing the second feeding operation, when only simplex scanning is performed.

24. A feeding and scanning method, comprising:
a first feeding operation to feed a medium, stacked in a supply tray and picked up by a pickup roller, to an image reading unit to scan one side of the medium;
a second feeding operation to reverse a feeding direction and to feed the medium, when the one side of the medium has been scanned through the first feeding operation and the other side of the medium is to be scanned, back to the image reading unit to scan the other side of the medium; and
a third feeding operation to feed the medium, when scanning of the medium has been completed, to a discharge roller, to discharge the medium,
wherein the medium is fed in the first feeding operation from the supply tray, and a side of the medium, facing upward as stacked in the supply tray, is discharged from the discharge roller facing down to arrange the medium in a corresponding order to the medium as stacked in the supply tray.

25. The method of claim 24, wherein an upward facing front side of the medium, as stacked in the supply tray, is discharged from the discharge roller facing down to arrange the medium in a corresponding order to the medium as stacked in the supply tray.

26. The method of claim 24, further comprising:
selectively feeding the medium to the discharge roller after the first feeding operation and the medium has passed through the image reading unit, without performing the second feeding operation, when performing simplex scanning, and
selectively reversing a medium feeding direction and feeding the medium, when the one side of the medium has been scanned through the first feeding operation and the other side of the medium is to be scanned, back to the image reading unit to scan the other side of the medium in the second feeding operation, when performing duplex scanning.

27. The method of claim 24, wherein the first feeding operation and the third feeding operation are performed, without performing the second feeding operation, when only simplex scanning is performed.

28. The method of claim 24, wherein a rear side of the medium, as stacked in the supply tray, is scanned first by the image reading unit.

29. A feeding and scanning method, comprising:
a first feeding operation to feed a medium, as stacked and picked up by a pickup roller, to an image reading unit to scan one side of the medium;
a second feeding operation to reverse a medium feeding direction and to feed the medium, when the one side of the medium has been scanned through the first feeding operation and the other side of the medium is to be scanned, back to the image reading unit to scan the other side of the medium; and
a third feeding operation to feed the medium, when scanning of the medium has been completed, to a discharge roller, to discharge the medium,
wherein the medium is discharged without an additional medium feeding operation to rearrange the medium in a corresponding order to an order of the medium as fed in the first feeding operation.

30. The method of claim 29, further comprising:
selectively feeding the medium to the discharge roller after the first feeding operation and the medium has passed through the image reading unit, without performing the second feeding operation, when performing simplex scanning, and
selectively reversing a medium feeding direction and feeding the medium, when the one side of the medium has been scanned through the first feeding operation and the other side of the medium is to be scanned, back to the image reading unit to scan the other side of the medium in the second feeding operation, when performing duplex scanning.

31. The method of claim 29, wherein the first feeding operation and the third feeding operation are performed, without performing the second feeding operation, when only simplex scanning is performed.

32. The method of claim 29, wherein a rear side of the medium, as stacked, is scanned first by the image reading unit.

33. A feeding and scanning apparatus including a pickup roller to pick up and feed a medium stacked in a supply tray, an image reading unit to scan an image of the medium, and a discharge roller to eject the scanned medium, the apparatus comprising:
an entry feeding path to feed, through the entry feeding path, the medium picked up by the pickup roller;
a connecting feeding path connected to a finishing end of the entry feeding path and extended to the image reading unit;
a reverse feed feeding path formed as a closed-loop to reverse feed the medium, through the reverse feed medium feeding path, when one side of the medium has been scanned by the image reading unit, back to the image reading unit to scan the other side of the medium, when duplex scanning of the medium is performed;
a simplex scan discharge feeding path to feed the medium, of which only one side of the medium is scanned by the image reading unit, to the discharge roller when performing simplex scanning; and
a duplex scan discharge feeding path to feed the medium to the discharge roller, when both sides of the medium are scanned by the image reading unit,
wherein the medium is discharged from the discharge roller with an upward facing side of the medium, as stacked in the supply tray, facing down to arrange the medium in a corresponding order to the medium as stacked in the supply tray.

34. The apparatus of claim 33, wherein a rear side of the medium, as stacked in the supply tray, is scanned first by the image reading unit.

35. The apparatus of claim 33, wherein, when the medium is fed to the image reading unit through the reverse feed feeding path to perform duplex scanning, the medium is then fed through the connecting feeding path to the image reading unit in the opposite direction to the direction the medium was fed for simplex scanning to the image reading unit.

36. The apparatus of claim 35, wherein the duplex scan discharge feeding path is partly overlapped with the connecting feeding path at a section to reverse feed the medium.

37. The apparatus of claim 33, further comprising:
a direction conversion member disposed adjacent to a location where the simplex scan discharge feeding path and the reverse feed feeding path meet,
wherein the direction conversion member directs the medium to the simplex scan discharge feeding path to feed the medium to the discharge roller after the medium has passed through the image reading unit when performing simplex scanning, and
wherein the direction conversion member directs the medium to advance into the reverse feed feeding path after the medium has passed through the image reading unit when performing duplex scanning.

38. The apparatus of claim 37, further comprising:
a first gate shutter positioned adjacent to the finishing end of the entry feeding path, wherein the first gate shutter guides the medium from the entry feeding path to the connecting feeding path during simplex scanning, and wherein the first gate shutter guides the medium to the duplex scan discharge feeding path during duplex scanning; and
a second gate shutter positioned adjacent to the simplex scan discharge feeding path, wherein the second gate shutter guides the medium that has passed through the image reading unit to the simplex scan discharge feeding path during simplex scanning, and wherein the second gate shutter guides the medium from the reverse feed feeding path back to the simplex scan discharge feeding path during duplex scanning.

39. The apparatus of claim 38, wherein the direction conversion member comprises a third gate shutter.

40. A feeding and scanning apparatus including a pickup roller to pick up and feed a medium stacked in a supply tray, an image reading unit to scan an image of the medium, and a discharge roller to eject the scanned medium, the apparatus comprising:
a duplex scan entry feeding path to feed the medium, through the duplex scan entry feeding path, from the pickup roller to the image reading unit to first scan one side of the medium when duplex scanning is performed;
a simplex scan entry feeding path to feed the medium, through the simplex scan feeding path, from the pickup roller to the image reading unit when only simplex scanning is performed;
a reverse feed feeding path formed as a closed-loop to reverse feed the medium, through the reverse feed feeding path, when the one side of the medium has been scanned by the image reading unit, back to the image reading unit to scan the other side of the medium, when duplex scanning of the medium is performed; and
a discharge feeding path to feed the medium, through the discharge feeding path, to the discharge roller, when scanning of medium has been completed,
wherein the medium is discharged from the discharge roller with an upward facing side of the medium, as stacked in the supply tray, facing down to arrange the medium in a corresponding order to the medium as stacked in the supply tray.

41. The apparatus of claim 40, wherein a rear side of the medium, as stacked in the supply tray, is scanned first by the image reading unit.

42. The apparatus of claim 40, wherein an upward facing front side of the medium, as stacked in the supply tray, is scanned first by the image reading unit.

43. The apparatus of claim 40, wherein the pickup roller and the discharge roller feed the medium in only one direction.

44. The apparatus of claim 40, wherein the duplex scan entry feeding path, the reverse feed feeding path, and the discharge feeding path include at least one feeding roller, and wherein the feeding roller feeds the medium in only one direction.

45. The apparatus of claim 40, wherein the reverse feed feeding path is partly overlapped with a simplex scan entry feeding path.

46. The apparatus of claim 40, further comprising:
a first direction conversion member disposed adjacent to the pick up roller,
wherein the first direction conversion member directs the medium that has passed through the pickup roller to advance into the simplex scan entry feeding path when performing simplex scanning, and
wherein the first direction conversion member directs the medium that has passed through the pickup roller to advance into the duplex scan entry feeding path when performing duplex scanning.

47. The apparatus of claim 46, further comprising:
a second direction conversion member disposed adjacent to a location where the simplex scan entry feeding path and the reverse feed feeding path meet,
wherein the second direction conversion member directs the medium being fed to the image reading unit through the simplex scan entry feeding path to continue to pass through to the discharge feeding path when performing simplex scanning, and
wherein the second direction conversion member directs the medium, when the one side of the medium has been scanned by the image reading unit after passing through the duplex scan entry feeding path, to advance into the reverse feed feeding path to scan the other side of the medium by the image reading unit when performing duplex scanning.
